(19) United States
(12) Patent Application Publication
(10) Pub. No.: US 2016/0350425 A1
(43) Pub. Date: Dec. 1, 2016

(54) METHODS AND SYSTEMS FOR SELECTING RESUMES FOR JOB OPENING

(71) Applicant: XEROX CORPORATION, Norwalk, CT (US)

(72) Inventors: Abhishek Tripathi, Bangalore (IN); Partha Dutta, Bangalore (IN); Preethy Varma, Cochin (IN); Avinash Sharma, Bangalore (IN); Varun Sharma, Kolkata (IN); Nischal Murthy Piratla, Fremont, CA (US)

(21) Appl. No.: 14/721,026

(22) Filed: May 26, 2015

(51) Int. Cl. G06F 17/30; G06F 3/0482; G06F 7/24

(52) U.S. Cl. CPC G06F 17/30867; G06F 17/3053; G06F 7/24; G06F 3/0482

(57) ABSTRACT

The disclosed embodiments illustrate methods and systems for selecting a set of resumes for a job description (JD). The method includes extracting at least a portion in each of a plurality of resumes based on a scoping criterion received from a user. The method further includes extracting one or more first features from said portion in each of said plurality of resumes. The method further includes selecting said set of resumes from said plurality of resumes based on a comparison between said one or more first features and said scoping criterion. Thereafter, the method includes displaying, by a display device, one or more second features of said selected set of resumes on a graphical user interface to said user. The method is performed by one or more microprocessors.

### TECHNICAL FIELD

The presently disclosed embodiments are related, in general, to document processing. More particularly, the presently disclosed embodiments are related to methods and systems for selecting resumes for a job opening.

### BACKGROUND

Organizations may usually receive a large number of resumes or job applications for a job opening. Analyzing such a huge number of the resumes or the job applications may be a humungous task for a human resource department of the organization.

With advancements in the field of software applications, various automated tools such as an applicant tracking system have been developed. The hiring manager may use such automated tools to rank the resumes or job applications and identify suitable candidates for the job opening. However, the existing automated tools may not allow the hiring manager to provide a feedback on the ranked list of the resumes or the job applications.

Current systems for collecting and evaluating resumes include: http://www.bright.com/; http://www.daxtra.com/; http://www.evolv.net/; http://www.hyrell.com/; http://www.theresumator.com/; http://www.sovren.com/; and http://nlp.stanford.edu/software/CRF-NER.shtml.

### SUMMARY

According to the embodiments illustrated herein, there is provided a method for selecting a set of resumes for a job description (JD). The method includes extracting at least a portion in each of a plurality of resumes based on a scoping criterion received from a user. The method further includes extracting one or more first features from said portion in each of said plurality of resumes. The method further includes selecting said set of resumes from said plurality of resumes based on a comparison between said one or more first features and said scoping criterion. Thereafter, the method includes displaying, by a display device, one or more second features of said selected set of resumes on a graphical user interface to said user. The method is performed by one or more microprocessors.

According to the embodiments illustrated herein, there is provided a system for selecting a set of resumes for a job description (JD). The system includes one or more microprocessors configured to extract at least a portion in each of a plurality of resumes based on a scoping criterion received from a user. The system further includes one or more microprocessors configured to extract one or more first features from said portion in each of said plurality of resumes. The system further includes one or more microprocessors configured to select said set of resumes from said plurality of resumes based on a comparison between said one or more first features and said scoping criterion. Thereafter, the system includes a display device configured to display one or more second features of said selected set of resumes on a graphical user interface to said user.

According to the embodiments illustrated herein, there is provided a computer program product for use with a computing device. The computer program product comprises a non-transitory computer readable medium, the non-transitory computer readable medium stores a computer program code for selecting a set of resumes for a job description (JD). The computer program code is executable by one or more microprocessors to extract at least a portion in each of a plurality of resumes based on a scoping criterion received from a user. The computer program code is further executable by one or more microprocessors to extract one or more first features from said portion in each of said plurality of resumes. The computer program code is further executable by one or more microprocessors to select said set of resumes from said plurality of resumes based on a comparison between said one or more first features and said scoping criterion. Thereafter, the computer program code is further executable by a display device to display one or more second features of said selected set of resumes on a graphical user interface to said user.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram illustrating a system environment in which various embodiments may be implemented;

FIG. 2 is a block diagram that illustrates a computing device for selecting a set of resumes for a job description (JD), in accordance with at least one embodiment;

FIG. 3 is a flowchart illustrating a method for selecting a set of resumes for a job description (JD), in accordance with at least one embodiment;

FIG. 4 is another flowchart illustrating a method for updating the ranked set of resumes based on a feedback, in accordance with at least one embodiment;

FIG. 5 is a block diagram illustrating a data structure, in accordance with at least one embodiment;

FIG. 6 is a block diagram illustrating a graphical user interface presented to a user, in accordance with at least one embodiment; and

FIG. 7 is a flow diagram illustrating an example of selecting a set of resumes for a job description, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the meanings set forth below.

“Job description” refers to a description of a set of job responsibilities that a candidate may have to undertake when selected for the job. In an embodiment, the job description may be defined by an organization, which is hiring one or more candidates. In an embodiment, the job description may include information pertaining to, but not limited, an educational qualification required for the job, a work experience required for the job, a skill set required for the job, a salary range offered by the organization, or a university ranking required for the job (i.e., a ranking of a university from which the candidate has graduated). In an embodiment, the information pertaining to the job description may correspond to one or more third features.

“Resume” refers to a document or a summary drafted by a candidate to present his/her background, skills, relevant job experience, and educational qualifications, to his/her prospective employer. In an embodiment, the resume may be utilized as an application for a job opening. In an embodiment, the organization may screen one or more resumes received for the job opening, to identify suitable candidates for the job opening. In an embodiment, the resume may be in a form of an electronic document.

“Electronic Document” refers to a collection of data, including image data, in any format, retained in an electronic form. The electronic document can contain one or more symbols, or the like. In an embodiment, the electronic document is obtained by scanning a corresponding physical document including, but not limited to, a handwritten document. The electronic document can be stored in various file formats, such as JPG or JPEG, GIF, TIFF, PNG, BMP, RAW, PSD, PSP, PDF, and the like. Various examples of the electronic document include, but are not limited to resumes, or job application forms.

“Scoping criterion” refers to a criterion that is received from a user (e.g., a hiring manager) for filtering out resumes/job applications of candidates who may not be suitable for the job opening. In an embodiment, the scoping criterion may include, but is not limited to, a time based scoping, a skill based scoping, an educational qualification based scoping, or the like.

“Portion” refers to a section of a resume that includes information about a candidate. In an embodiment, the information about the candidate may be related to the scoping criterion that is provided by the user (e.g., a hiring manager). The section of the resume may include, but is not limited to, an educational qualification, a work experience, and publications of the candidate. For example, if the scoping criterion provided by the user is a number of publications of the candidate, the section of the resume corresponding to the publication may constitute the portion of the resume.

“One or more first features” refer to one or more features that may be extracted from the portion in each of the plurality of resumes. In an embodiment, the one or more first features may include, but are not limited to, an educational qualification, a work experience, a skill set, or a university ranking of a candidate. For example, if the portion of the resume is related to the professional experience of a candidate, the one or more first features corresponding to the professional experience may include, but are not limited to, a name of a previous company of the candidate, a tenure of the candidate at the previous company, roles and responsibilities of the candidate during the tenure, or ranking of the previous company.

“Set of resumes” refer to one or more resumes that may be selected from plurality of resumes. In an embodiment, the set of resumes may be selected for the job description based at least on the scoping criterion received from the user, or the one or more first features associated with each resume in the plurality of resumes.

Graphical User Interface OR “GUI” refers to an interface that facilitates the user to interact with associated computing devices. The user can interact with the GUI using various input mediums/techniques including, but not limited to, a keypad, a mouse, a joystick, any touch-sensitive medium (e.g., a touch-screen or touch sensitive pad), a voice recognition system, gesture recognition system, and so forth. In an embodiment, the GUI may include one or more portions.

“User” refers to an individual or a team of individuals who select resumes for job descriptions. In an embodiment, the user may correspond to a hiring manager or an interviewer. In an embodiment, the user may provide a scoping criterion for the job description. Further, the user may receive a ranked list of a set of resumes based on the scoping criterion. On the received ranking, the user may provide a feedback.

“Feedback” refers to an input provided by the user on the ranked list of resumes displayed to the user. In an embodiment, the input may correspond to a selection of at least one resume from the list of ranked resumes by the user. Further, the input may correspond to a reordering of the ranked list of resumes by the user.

“One or more second features” refer to one or more features that may be extracted from the selected set of resumes. In an embodiment, the one or more second features of the selected set of resumes may be displayed on the GUI to the user. The one or more second features may include, but are not limited to, an educational qualification, a work experience, a skill set, or a university ranking of a candidate.

“Weights” refer to a value assigned to each of the one or more second features associated with each resume in the set of resumes. In an embodiment, uniform weights or user-specified weights may be assigned to each of the one or more second features. In an embodiment, the weights may be updated based on the feedback received from the user.

“Final Score” refers to a value determined for each resume in the set of resumes. In an embodiment, the final score may be determined based on the weights assigned to each of the one or more second features associated with each resume in the set of resumes.

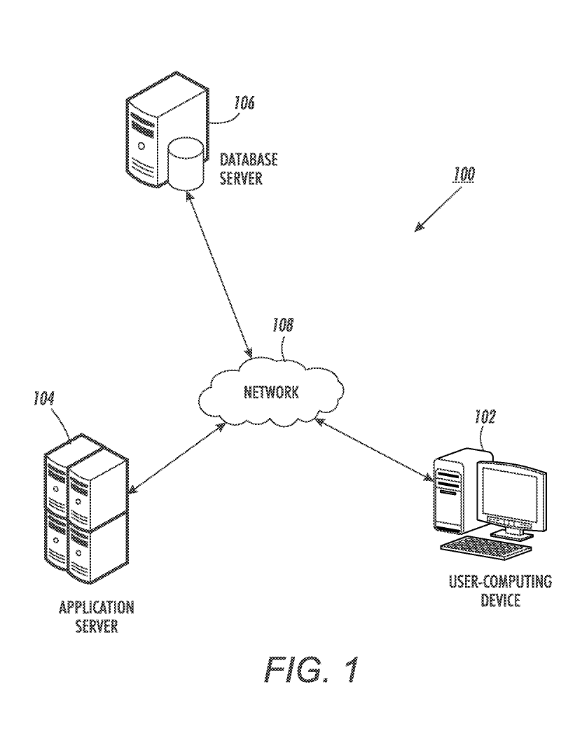

FIG. 1 is a block diagram illustrating a system environment 100 in which various embodiments may be implemented. The system environment 100 includes a user-computing device 102, an application server 104, a database server 106, and a network 108. Various devices in the system environment 100 (e.g., the user-computing device 102, the application server 104, and the database server 106) may be interconnected over the network 108.

The user-computing device 102 may refer to a computing device, used by a user, to select a set of resumes for a job description associated with a job opening. In an embodiment, the user-computing device 102 includes one or more processors, and one or more memories that are used to store instructions. These instructions are executable by the one or more processors to perform a predetermined operation. In an embodiment, the user of the user-computing device 102 may provide inputs through the user-computing device 102 to define/draft the job description for the job opening. In an embodiment, the job description may have one or more third features. Further, the user-computing device 102 may store the job description in the database server 106. In an embodiment, the user-computing device 102 may receive a plurality of resumes from applicants or candidates for the job opening. The plurality of resumes may be received through various electronic communication mediums such as online portals, emails, etc. Further, third party vendors (such as recruitment consultancies) may send the plurality of resumes to the user-computing device 102. On receiving the plurality of resumes, the user-computing device 102 may store the plurality of resumes in the database server 106. In an embodiment, the user-computing device 102 may present a graphical user interface to the user, displaying the plurality of resumes received for the job opening. In an embodiment, the user of the user-computing device 102 may provide an input through the graphical user interface to define a scoping criterion. The scoping criterion may be utilized for identifying at least a portion in each of the plurality of resumes. In an embodiment, the user-computing device 102 may store the scoping criterion in the database server 106. Further, the user associated with the user-computing device 102 may select (by providing an input through the user-computing device 102) one or more first features of each resume in the plurality of resumes. In an embodiment, the user associated with the user-computing device 102 may receive a ranking of the set of resumes based on the one or more second features associated with each resume in the set of resumes and one or more third features of the job description. Further, the user-computing device 102 may display the ranked list of resumes to the user through a GUI received from the application server 104. The user may provide input to select a resume from the ranked list of resumes, or to reorder the ranked set of resumes. The input from received from the user may be considered a feedback and may be sent to the application server 104 by the user-computing device 102. Thereafter, the user-computing device 102 may receive updated ranking of the set of resumes from the application server 104, based on the feedback. The user-computing device 102 may then display the updated ranking of the set of resumes to the user through the GUI.

In an embodiment, the user-computing device 102 may have a coupled input device that may be configured to receive the one or more inputs provided by the user of the user-computing device 102. In an embodiment, the input device may correspond to a keyboard, a mouse, or a touch screen. The user-computing device 102 may be realized through a variety of computing devices, such as, but not limited to, a desktop, a computer server, a laptop, a personal digital assistant (PDA), a tablet computer, and the like.

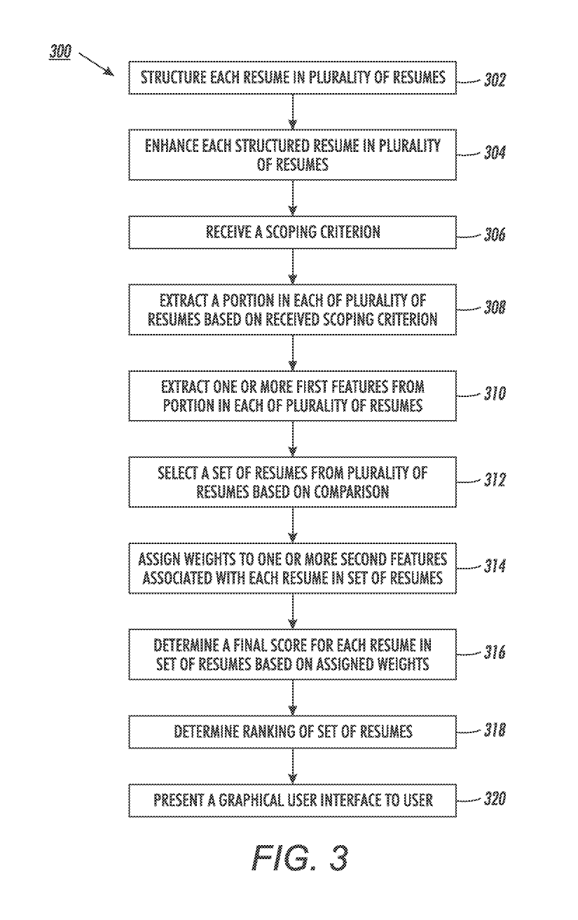

The application server 104 may refer to a computing device configured to select the set of resumes for the job description of the job opening. In an embodiment, the application server 104 includes one or more processors, and one or more memories coupled to the one or more processors. The one or more memories are used to store instructions that are executable by the one or more processors to perform a predetermined operations. In an embodiment, the application server 104 may receive the job description for the job opening from the user-computing device 102 (as defined by the user of the user-computing device 102). In alternate embodiment, the application server 104 may extract the job description from the database server 106, if the job description is stored in the database server 106. Thereafter, the application server 104 may extract the one or more third features from the job description. Further, the application server 104 may extract the plurality of resumes from the database server 106. In another embodiment, the application server 104 may receive the plurality of resumes from the user-computing device 102. Further, the application server 104 may enhance each of the plurality of resumes by adding information such as a university ranking from which an applicant/candidate has graduated, or a ranking of previous company of the applicant/candidate. In an embodiment, the application server 104 may receive the scoping criterion from the user-computing device 102. Based on the scoping criterion, the application server 104 may extract at least a portion in each of the plurality of resumes. Thereafter, the application server 104 may extract one or more first features from the identified portion of each of the plurality of resumes. The application server 104 may further select the set of resumes from the plurality of resumes based on a comparison between the one or more first features and the scoping criterion. Post selection of the set of resumes, the application server 104 may determine the one or more second features of each resume in the set of resumes. In an embodiment, the application server 104 may assign weights to the one or more second features associated with each resume in the set of resumes. Based on the weights assigned to each of the one or more second features, the application server 104 may determine a final score for each resume in the set of resumes. Further, the application server 104 may rank the set of resumes based on the determined final score. Thereafter, the application server 104 may present a graphical user interface to the user through the user-computing device 102. The graphical user interface (GUI) may be utilized for displaying the one or more second features of the selected set of resumes, and the ranked set of resumes to the user associated with the user-computing device 102. Further, the application server 104 may receive a feedback of the user through the user-computing device 102. The feedback may correspond to an input provided by the user to select a resume from the ranked set of resumes, or a reordering the ranked set of resumes. Based on the feedback of the user, the application server 104 may update the ranking of the set of resumes. The ranking of the set of resumes has been described later in conjunction with FIG. 3.

The application server 104 may be realized through various types of application servers such as, but not limited to, Microsoft® SQL server, Java application server, .NET framework, Base4, Oracle, and My SQL.

A person skilled in the art will appreciate that the scope of the disclosure is not limited to the application server 104 and the user-computing device 102 being separate entities. In an embodiment, the application server 104 may correspond to an application hosted on or running on the user-computing device 102 without departing from the spirit of the disclosure.

The database server 106 may refer to a device or a computer that maintains a repository of plurality of resumes. The plurality of resumes may be stored in different file formats such as ASCII text, .PDF, or .DOC file, and so on. In an embodiment, the database server 106 may store the one or more first features associated with each resume in the plurality of resumes. Further, the database server 106 may store each resume in the plurality of resumes in a structured way such as a linked list data structure. In an embodiment, the database server 106 may store additional information such as a university ranking of the applicant/candidate, or a ranking of a previous company of the applicant/candidate to enhance the structured resumes. In an embodiment, the database server 106 may store one or more third features associated with the job description of the job opening. Further, the database server 106 may store a scoping criterion received from the user-computing device 102. The scoping criterion may correspond to one or more of a time-based scoping, a skill domain based scoping, or an educational qualification based scoping. In an embodiment, the database server 106 may further store the one or more second features of the selected set of resumes. Further, the database server 106 may store a final score for each resume in the set of resumes. In an embodiment, the database server 106 may store ranked set of resumes for the job description.

In an embodiment, the database server 106 may be configured to transmit or receive one or more instructions/tasks/information/features to/from one or more devices, such as the user-computing device 102, and the application server 104 over the network 108. The database server 106 may be implemented using technologies including, but not limited to, Oracle®, IBM DB2®, Microsoft SQL Server®, Microsoft Access®, PostgreSQL®, MySQL® and SQLite®, and the like. In an embodiment, the user-computing device 102 and/or the application server 104 may connect to the database server 106 using one or more protocols such as, but not limited to, ODBC protocol and JDBC protocol.

It will be apparent to a person skilled in the art that the functionalities of the database server 106 may be incorporated into the application server 104, without departing from the scope of the disclosure.

The network 108 corresponds to a medium through which content and messages flow between various devices of the system environment 100 (e.g., the user-computing device 102, the application server 104, and the database server 106). Examples of the network 108 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 108 in accordance with various wired and wireless communication protocols such as Transmission Control Protocol and Internet Protocol (TCP/IP), User Datagram Protocol (UDP), and 2G, 3G, or 4G communication protocols.

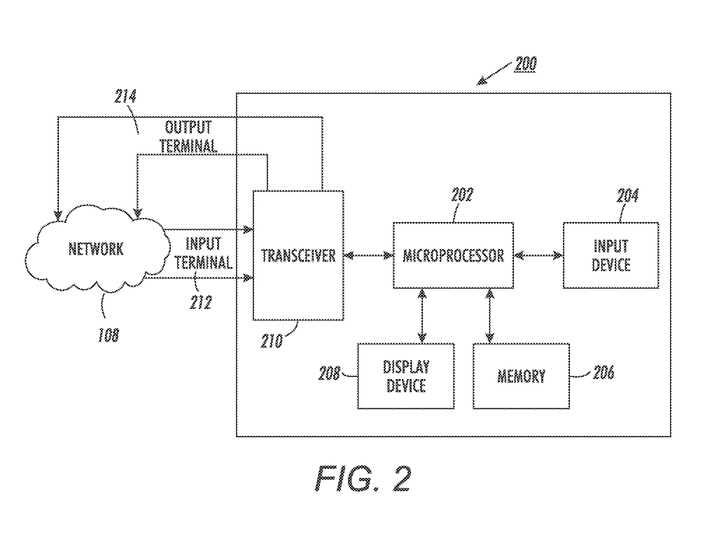

FIG. 2 is a block diagram that illustrates a computing device 200 for selecting a set of resumes for a job description of a job opening, in accordance with at least one embodiment. For the purpose of the ongoing disclosure, the computing device 200 has been considered the application server 104. However, the scope of the disclosure should not be limited to the computing device 200 as the application server 104. The computing device 200 can also be realized as the user-computing device 102 without departing from the spirit of the disclosure.

The computing device 200 includes a microprocessor 202, an input device 204, a memory 206, a display device 208, a transceiver 210, an input terminal 212, and an output terminal 214. The microprocessor 202 is coupled to the input device 204, the memory 206, the display device 208, and the transceiver 210. The transceiver 210 may connect to the network 108 through the input terminal 212 and the output terminal 214.

The microprocessor 202 includes suitable logic, circuitry, and/or interfaces that are operable to execute one or more instructions stored in the memory 206 to perform predetermined operations. The microprocessor 202 may be implemented using one or more processor technologies known in the art. Examples of the microprocessor 202 include, but are not limited to, an x86 microprocessor, an ARM microprocessor, a Reduced Instruction Set Computing (RISC) microprocessor, an Application Specific Integrated Circuit (ASIC) microprocessor, a Complex Instruction Set Computing (CISC) microprocessor, or any other microprocessor.

The input device 204 may comprise suitable logic, circuitry, interfaces, and/or code that may be operable to receive an input from the user. In a scenario where the computing device 200 corresponds to the user-computing device 102, the input device 204 may be a part of the user-computing device 102. Further, the input device 204 may receive a scoping criterion from the user. The input device 204 may be operable to communicate the input received from the user to the microprocessor 202. Examples of the input devices may include, but are not limited to, a touch screen, a keyboard, a mouse, a joystick, a microphone, a camera, a motion sensor, a light sensor, and/or a docking station.

The memory 206 stores a set of instructions and data. Some of the commonly known memory implementations include, but are not limited to, a random access memory (RAM), a read only memory (ROM), a hard disk drive (HDD), and a secure digital (SD) card. Further, the memory 206 includes the one or more instructions that are executable by the microprocessor 202 to perform specific operations. It is apparent to a person with ordinary skills in the art that the one or more instructions stored in the memory 206 enable the hardware of the computing device 200 to perform the predetermined operations.

In an embodiment, the display device 208 may comprise suitable logic, circuitry, interfaces, and/or code that may be operable to render a graphical user interface. In a scenario where the computing device 200 corresponds to the user-computing device 102, the display device 208 may be a part of the user-computing device 102. In an embodiment, the display device 208 may display the plurality of resumes for the job description to the user of the user-computing device 102. Further, the display device 208 may display one or more first features of each resume in the plurality of resumes, and one or more third features of the job description on the GUI. In an embodiment, the display device 208 may be a touch screen that enables the user to provide an input. In an embodiment, the touch screen may correspond to at least one of a resistive touch screen, capacitive touch screen, or a thermal touch screen. In an embodiment, the display device 208 may further receive the input through a virtual keypad, a stylus, a gesture, and/or a touch based input. In an embodiment, when the display device 208 has a touch screen, the display device 208 may receive a scoping criterion from the user of the user-computing device 102. Further, the display device 208 may receive feedback on the ranked list of resumes. In an embodiment, the display device 208 may be realized through several known technologies such as, but not limited to, Cathode Ray Tube (CRT) based display, Liquid Crystal Display (LCD), Light Emitting Diode (LED) based display, Organic LED display technology, and Retina display technology. Further, the display device 208 may display one or more second features of selected set of resumes on the graphical user interface to the user. In an embodiment, the display device 208 may be capable of receiving feedback from the user of the user-computing device 102.

The transceiver 210 transmits and receives messages and data to/from various components of the system environment 100 (e.g., the user-computing device 102, and the database server 106) over the network 108. In an embodiment, the transceiver 210 may receive a scoping criterion from the user-computing device 102. The transceiver 210 may further receive a feedback of the user from the user-computing device 102. In an embodiment, the transceiver 210 is coupled to the input terminal 212 and the output terminal 214 through which the transceiver 210 may receive and transmit data/messages, respectively. Examples of the input terminal 212 and the output terminal 214 include, but are not limited to, an antenna, an Ethernet port, a USB port, or any other port that can be configured to receive and transmit data. The transceiver 210 receives and transmits data/messages in accordance with the various communication protocols such as, TCP/IP, UDP, and 2G, 3G, or 4G communication protocols through the input terminal 212 and the output terminal 214.

The operation of the computing device 200 for selection of a set of resumes for a job description associated with a job opening has been described later in conjunction with FIG. 3.

FIG. 3 is a flowchart 300 illustrating a method for selecting a set of resumes for a job description (JD) associated with a job opening, in accordance with at least one embodiment. The flowchart 300 has been described in conjunction with FIG. 1 and FIG. 2.

At step 302, each resume in the plurality of resumes is structured. In an embodiment, the microprocessor 202 may structure each resume in the plurality of resumes. In an embodiment, the microprocessor 202 may receive the job description from the user-computing device 102. The job description may define one or more of a required number of years of experience, a required qualification, or a required domain knowledge for the job opening. Prior to structuring the plurality of resumes, the microprocessor 202 may retrieve the plurality of resumes from the database server 106. In an embodiment, the user-computing device 102 may receive the plurality of resumes or the job applications from an online resume/job portal or a third party. Thereafter, the user-computing device 102 may store the plurality of resumes in the database server 106. In an embodiment, the plurality of resumes may be stored in various file formats such as form based, ASCII text, .PDF, or .DOC file and so on.

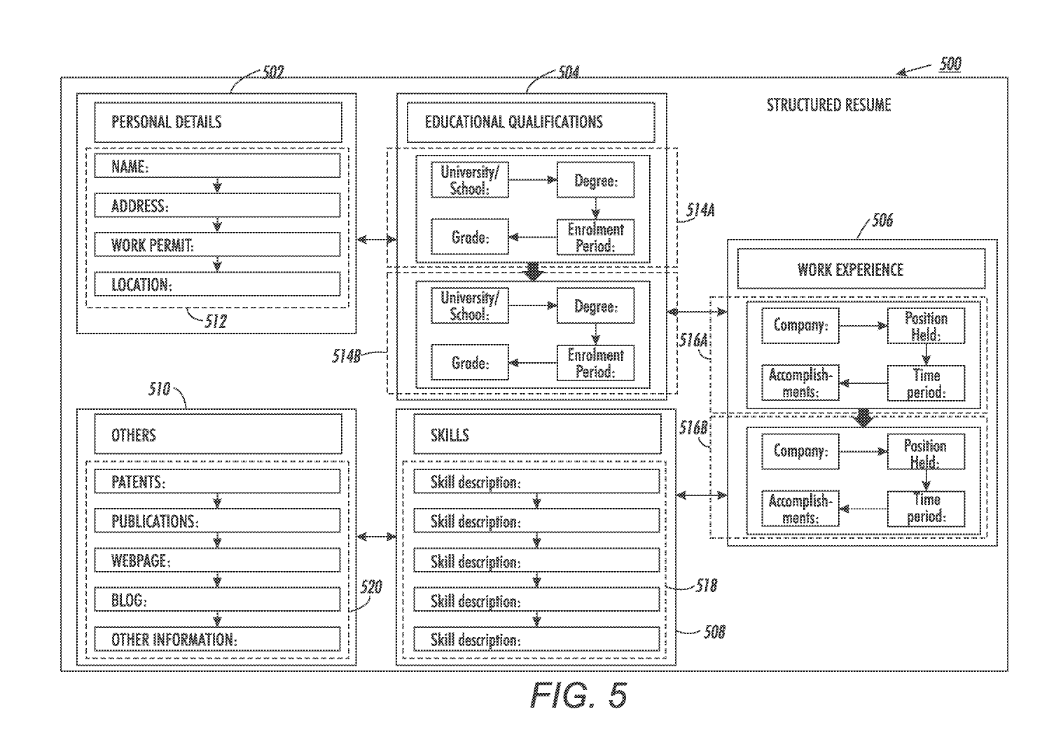

Post retrieval of the plurality of resumes from the database server 106, in an embodiment, the microprocessor 202 may structure each resume in the plurality of resumes as a linked list data structure. In an embodiment, the structuring of each resume as the linked list data structure may include extracting each section of each resume in the plurality of resumes. In an embodiment, the resume may include one or more sections pertaining to person details, educational qualifications, work experience, skills, and miscellaneous details. For each section, the microprocessor 202 creates a linked list that includes information contained in the respective section. For example, for the section personal details, the linked list may include information such as a name of the candidate, a residential address of the candidate, a work permit of the candidate, and a location preference of the candidate. A person having ordinary skill in the art would understand that the scope of the disclosure is not limited to personal details containing only the above mentioned information. The linked list data structure has been further described later in conjunction with FIG. 5. In an embodiment, the microprocessor 202 may utilize various parsing tools such as, but not limited to, a resume parsing tool, or a CV parsing tool to extract each section of each resume in the plurality of resumes.

In an embodiment, if the resume is in the form of an image, then the microprocessor 202 may perform an Optical Character Recognition (OCR) or an Intelligent Character Recognition (ICR) operation on the resume. Thereafter, the microprocessor 202 may utilize the CV parsing tool to extract each section of the resume. Further, each section of the resume may be represented in the linked list data structure.

It will be apparent to a person with ordinary skill in the art that the above-mentioned tools to extracting each section of the resume have been provided only for illustration purposes and should not limit the scope of the disclosure.

At step 304, each structured resume in the plurality of resumes is enhanced. In an embodiment, the microprocessor 202 may enhance each structured resume by adding information such as, but not limited to, a university ranking of the candidate, or a ranking of a previous company of the candidate. For example, if a structured resume does not include the university ranking of the university from which the candidate has graduated, the microprocessor 202 may add university ranking to the structured resume. In an embodiment, the microprocessor 202 may obtain the university ranking from various public sources such as Times Higher Education Ranking, and other educational magazines or newspapers. Similarly, the microprocessor 202 may determine ranking of a previous company in which the candidate worked. In an embodiment, the microprocessor 202 may obtain the ranking of the companies from trusted sources such as Forbes, CNN, etc.

It will be apparent to a person with ordinary skill in the art that the information utilized to enhance the resumes is not limited to the university ranking and the ranking of the companies. In an embodiment, the microprocessor 202 may enhance each structured resume by adding the information such as a number of citations of the publications authored by the candidate, a ranking of the publication, and a ranking of the conference in which the publication was presented, without departing from the scope of the disclosure.

In an embodiment, the microprocessor 202 may store the information in a knowledge base. The knowledge base (not shown) may be a part of the system environment 100, and may be utilized to extract the information such as the university ranking of the candidate, or the ranking of the previous company of the candidate from various external APIs such as, but not limited to, LinkedIn, GitHub, ArnetMiner, Google Knowledge Graph, web-crawling APIs, or a subject matter expert input. In an embodiment, the microprocessor 202 may further refresh the Knowledge base at regular intervals of time using external web sources.

At step 306, a scoping criterion is received. In an embodiment, the microprocessor 202 may receive the scoping criterion from the user-computing device 102. In an embodiment, the user may define the scoping criterion by providing an input through the input device 204 of the user-computing device 102. In an embodiment, the application server 104 may display a GUI on the user-computing device 102. The GUI may include a portion that presents one or more options, from which the user may provide the input to select the scoping criterion. In an embodiment, the one or more options may be predefined. In an embodiment, the one or more options may include, but are not limited to, a time based scoping, a skill domain based scoping, or an educational qualification based scoping. In an embodiment, the user may provide input through the input device 204 of the user-computing device 102 to select any one option from the one or more options as the scoping criterion. Further, in an embodiment, after selecting the scoping criterion, the user may further set a threshold value for the scoping criterion. For instance, the user provides an input to select a time-based scoping criterion. In such a scenario, the user is presented with further options such as total work experience of the candidate, total years of experience of the candidate etc. The user may further provide another input to select at least one of the further options or a combinations of the further options. For example, in the time-based scoping, the user may select the option of the total work experience of the candidate. Thereafter, the user may define the threshold of the total work experience as five years.

It will be apparent to a person with ordinary skill in the art that the scoping criterion mentioned-above has been provided only for illustration purposes and should not limit the scope of the disclosure. In an embodiment, the microprocessor 202 may employ skill-based scoping, etc., without departing from the scope of the disclosure.

In an embodiment, the one or more options may be determined based on the one or more third features of the job description. In such type of scenario, the microprocessor 202 determines the one or more third features associated with the job description. For instance, the one or more third features may include a minimum work experience required, a total number of publications authored by the candidate, and a total number of patents filed by the candidate, and so forth. The microprocessor 202 may utilize one or more predefined rules to determine the one or more options. For example, if the predefine rule is the work experience, the microprocessor 202 may display an option of the work experience. Similarly, the microprocessor 202 may display options pertaining to the number of patents and the number of publications.

A person having ordinary skilled in the art would understand that as the job description for different jobs may be different, the one or more options for different jobs may also be different. For example, the job description is related to a job opening for a patent drafting professional and the job description describes that the candidate must have drafted more than 60 patent applications. In such a scenario, the microprocessor 202 may create and an option pertaining to a number of patent application drafted.

In another embodiment, the user may manually add an option pertaining to a scoping criterion. In an embodiment, the GUI may provide the user with a functionality of adding the option.

At step 308, a portion in each of the plurality of resumes is extracted based on the scoping criterion received from the user. In an embodiment, the microprocessor 202 may receive the scoping criterion from the user-computing device 102 (as discussed in the step 306). In an embodiment, the portion may correspond to a section of the resume that includes information pertaining to the scoping criterion. For instance, if the scoping criterion provided by the user is the number of publications, the section of the resume corresponding to the publications by the candidate may constitute the portion of the resume. In an embodiment, the microprocessor 202 may utilize a named-entity recognition method to extract the portion in each of the resume. For instance, if the microprocessor 202 receives a time period for the work experience as the scoping criterion, then the microprocessor 202 may perform the time-based scoping to identify the portion in each of the plurality of resumes, which corresponds to the work experience of the respective candidate.

At step 310, one or more first features from the portion are extracted. In an embodiment, the microprocessor 202 may extract the one or more first features from the portion in each of the plurality of resumes. In an embodiment, the one or more first features extracted from the plurality of resumes may vary based on the type of portion extracted from the plurality of resumes. For example, if the portion extracted from the plurality of resumes corresponds to a work experience, then the one or more first features may include a total work experience listed in the plurality of resumes. Similarly, if the portion extracted from the plurality of resumes corresponds to educational qualifications, then the one or more first features may include one or more degrees achieved by the candidate, and a university ranking of a university from which the candidate has graduated. In an embodiment, the microprocessor 202 may employ different extraction techniques such as the named-entity recognition method or the CV parsing tools to extract the one or more first features from the extracted portion.

As discussed above, each of the plurality of resumes may be structured and stored in the form of linked lists. The one or more first features may be extracted directly from the linked list portion.

A person skilled in the art will understand that the extraction techniques mentioned-above have been provided only for illustration purposes and should not limit the scope of the disclosure to these techniques only.

At step 312, a set of resumes from the plurality of resumes are selected. In an embodiment, the microprocessor 202 may select the set of resumes from the plurality of resumes based on a comparison between the one or more first features and the scoping criterion. For example, the threshold provided by the user for the work experience scoping criterion is 3 years. The microprocessor 202 may extract the one or more first features (e.g., name of a company, ranking of a previous company, etc.) from the extracted portion corresponding to the work experience. Based on a comparison between the one or more extracted first features and the received scoping criterion, the microprocessor 202 may select the set of resumes from the plurality of resumes whose time period for work experience matches or is greater than the time period (3 years) specified by the user as the scoping criterion.

At step 314, weights are assigned to one or more second features associated with each resume in the set of resumes. In an embodiment, the microprocessor 202 may assign weights to the one or more second features associated with each resume in the set of resumes. In an embodiment, the microprocessor 202 may extract the one or more second features of each resume in the set of resumes using at least one of the resume parsing tool or the CV parsing tool. In an alternate embodiment, the microprocessor 202 extracts the one or more second features from the linked list data structures. In an embodiment, the one or more second features may include, but are not limited to, an educational qualification of the candidate, a work experience of the candidate, a skill set of the candidate, or a university ranking of a university from which the candidate has graduated. In an embodiment, the one or more second features may be classified under two categories based on a presence/absence of the one or more second features in the job description. The first category may correspond to the second features listed in the job description, such as, but not limited to, the educational qualification of the candidate, the work experience of the candidate, and the skill set of the candidate. The second category may include second features that are not listed in the job description, such as, but not limited to, a university ranking of the candidate.

In an embodiment, the weights may be assigned to the second features categorized in the first category (i.e., features listed in the job description). In an embodiment, the weights may be user-specified weights or uniform weights, wⱼ. In an embodiment, the microprocessor 202 may utilize following equation to assign the weights:

Σⱼwⱼ1 (1)

where,

wⱼ=Uniform weights or User Specified weights.

In an embodiment, the weights may be uniformly distributed between the second features in the first category, such that the equation 1 is satisfied. For example, if the selected set of resumes include resumes ‘A, B, and C’. The microprocessor 202 may utilize the equation 1 to assign weights to the second features associated with the resumes ‘A, B, and C’. In an alternate embodiment, the microprocessor 202 may receive an input to define the weights.

At step 316, a final score for each resume in the set of resumes is determined. In order to determine the final score, the microprocessor 202 may determine a first score and a second score for each resume in the set of resumes. In an embodiment, the first score corresponds to a score determined based on the weights assigned to the second features classified in the first category. In an embodiment, the second score corresponds to a score determined based on the second features classified in the second category.

The microprocessor 202 may determine the first score for each resume in the set of resumes based on the weights assigned to the second features, classified in the first category. In an embodiment, the microprocessor 202 may utilize following equations to determine the first score based on the assigned weights:

Sᵢ=F(Rᵢ), where Rᵢ={v₁, . . . ,v_{q}} (2)

Sᵢ=F(Rᵢ)=Σ_{q}wⱼfⱼ(vᵢ)=Σ_{q}wⱼxⱼ (3)

where,

Sᵢ=First Score for each resume in the set of resume i,

Rᵢ=Set of resumes, where i=1, . . . N,

F=Scoring Function for the first score, where F: R→S,

vⱼ=Second features, in the first category, where fⱼ:vⱼ→R,

wⱼ=Weights of second features, in the first category,

xⱼ=fⱼ(vⱼ)=Score of feature vⱼ based on scoring function, fⱼ.

In an embodiment, the microprocessor 202 may determine the second score for each resume in the set of resumes based on the second features, classified in the second category. For example, in an embodiment, the microprocessor 202 may determine the second score based on the university ranking. In an embodiment, the microprocessor 202 may utilize the following equation to determine the second score based on the university ranking:

$$f ( {f}^{r} ) = \frac{1}{rank} \qquad ( 4 )$$

where,

f(f^{r})=Scoring Function for the second score,

f^{r}=Second features, in the second category,

rank=University ranking.

It will be apparent to a person with ordinary skill in the art that the university ranking mentioned-above to determine the second score has been provided only for illustration purposes and should not limit the scope of the disclosure. In an embodiment, the microprocessor 202 may determine second score based on rank of companies etc., without departing from the scope of the disclosure.

Post determining the first score and the second score, the microprocessor 202 may determine final score for each resume in the set of resumes based on the first score and the second score associated with each resume in the set of resumes. In an embodiment, the microprocessor 202 may utilize following similarity function:

f:(f^{r},f^{j})→R (5)

At step 318, ranking of the set of resumes is determined. In an embodiment, the microprocessor 202 may determine rank of the resumes in the set of resumes based on the final score. In an embodiment, the microprocessor 202 determines the final score for each resume in the set of resumes based on the assigned weights as discussed above. For example, as discussed above, the final score of the resumes A, B, and C are 1, 0.5, and 0.7. Based on the final score, the microprocessor 202 determines the ranking of the selected set of resumes as A, C, and B.

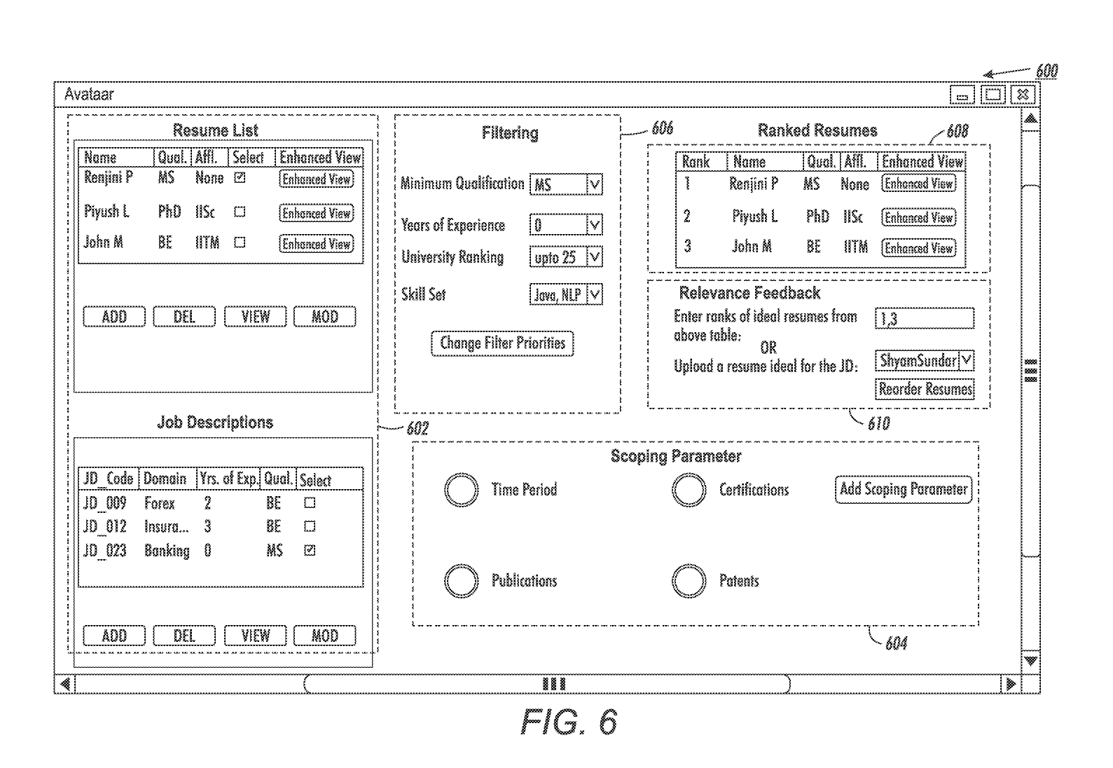

At step 320, a graphical user interface is presented to the user. In an embodiment, the microprocessor 202 may present the graphical user interface to the user. The graphical user interface may facilitate a display of the ranked set of resumes to the user. In an embodiment, the microprocessor 202 may further display the one or more second features associated with each resume in the selected set of resumes. For example, as discussed above, if the ranking of the selected set of resumes are A, C, and B, then the microprocessor 202 displays the ranking of the set of resumes (i.e. A, C, and B) on the graphical user interface to the user. The graphical user interface (GUI) has been described later in conjunction with the FIG. 6.

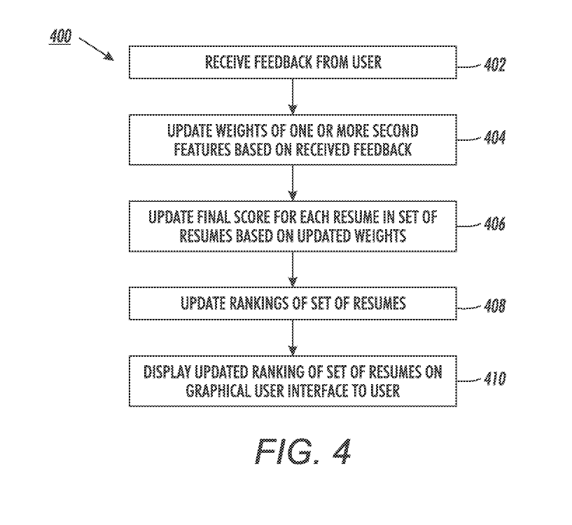

FIG. 4 is another flowchart 400 illustrating a method for updating the ranked set of resumes based on the feedback, in accordance with at least one embodiment. The flowchart 400 has been described in conjunction with FIG. 1, FIG. 2, and FIG. 3.

At step 402, a feedback of the user is received. In an embodiment, the microprocessor 202 may receive the feedback of the user on the ranked set of resumes from the user-computing device 102. As discussed above in the step 320, the ranked set of resumes may be displayed on the graphical user interface to the user. The user may provide the feedback in response to the ranked set of resumes displayed to the user. In an embodiment, the feedback may correspond to at least the user selecting a resume from the ranked set of resumes, or the user reordering the ranked set of resumes. For example, as discussed above, the ranked set of resumes are A, C, and B. The candidate associated with the resume B may have taken a half-year long sabbatical for medical reasons in his/her 3^{rd} year of working experience. The user may realize that the performance of this candidate may be compromised in the future. In such type of scenario, the user may provide a feedback of ignoring resumes of candidates with gap years. Based on the received feedback, the microprocessor 202 may identify resumes from the set of resumes that have a gap year. Based on the comparison, the microprocessor 202 may remove resumes, from the list of ranked set of resumes, which have a gap year. Thereafter, the user may receive the ranked set of resumes that will not include the resume B.

In an embodiment, the user may provide the feedback by moving a resume up or down in the ranked set of resumes (i.e., modifying the rank of the resumes in the list of ranked set of resumes).

At step 404, the weights of the one or more second features associated with each resume in the set of resumes are updated. In an embodiment, the microprocessor 202 may update the weights of the one or more second features associated with each resume in the set of resumes based on the feedback received from the user. For example, if the user provides the feedback that consider only 2 years of the work experience instead of the 3 years, then the weights of the one or more second features associated with each resume in the set of resumes may be accordingly updated. In this type of scenario, more weightage may be given to the second feature of the work experience in comparison to other of the one or more second features. In an embodiment, the microprocessor 202 may utilize following equation to update the weights based on the feedback:

$${w}_{j}^{t} = {w}_{j}^{( t - 1 )} + \frac{{Σ}_{z} {w}_{r} {x}_{r}^{z}}{{Σ}_{q} ( {Σ}_{z} {w}_{r} {x}_{r}^{z} )} \qquad ( 6 )$$

where,

wⱼ^{t}=Weight of feature vⱼ at iteration t,

wⱼ^{(t-1)}=Weight of feature vⱼ at iteration (t−1),

wᵣ=Weight of feature vᵣ.

In an embodiment, the microprocessor 202 may further normalize the updated weights of the one or more second features associated with each resume in the set of resumes. Further, the microprocessor 202 may utilize the following equation to normalize the updated weights at each iteration:

Σⱼwⱼ^{t}=1 (7)

where,

wⱼ^{t}=Weight of feature vⱼ at iteration t.

In a scenario, where the feedback corresponds to reordering the ranked list of set of resumes, the microprocessor 202 may update the weights of the one or more second features by utilizing the following equations:

MinΣⱼεⱼ² (8)

Σⱼ(wⱼ+εⱼ)xⱼ[σ(k)]≧Σⱼ(wⱼ+εⱼ)xⱼ[σ(k+1)]; 1≦k≦N−1 (9)

where,

k^{th}=Ranked resumes,

R_{σ(k)}=Re-Ranked resumes,

εⱼ=Decision Variable,

xⱼ[σ(k)]=Final Score of resume R_{σ(k)} for feature j,

wⱼ,xⱼ[σ(k)]=Constants.

In an embodiment, the microprocessor 202 may determine the decision variable, εⱼ by utilizing the equations 8 and 9. In an embodiment, the decision variable, εⱼ is the amount by which the weight, wⱼ is changed.

At step 406, a final score for each resume in the set of resumes is updated. In an embodiment, the microprocessor 202 may update the final score for each resume in the set of resumes based on the updated weights as discussed above in the step 404. In an embodiment, the microprocessor 202 may utilize the equations 2 and 3 to determine the final score based on the updated weights.

At step 408, the ranking of the set of resumes is updated. In an embodiment, the microprocessor 202 may update the ranking of the set of resumes based on the updated final score.

At step 410, the updated ranked list of set of resumes is displayed on the graphical user interface to the user in the same manner as discussed in the step 320.

FIG. 5 is a block diagram illustrating a linked list data structure 500, in accordance with at least one embodiment. The linked list data structure 500 has been described in conjunction with FIG. 1, FIG. 2, FIG. 3, and FIG. 4.

As shown in FIG. 5, the linked list data structure (depicted by 500) includes one or more portions (as discussed in the step 302). The linked list data structure 500 includes a first portion 502, a second portion 504, a third portion 506, a fourth portion 508, and a fifth portion 510. The first portion 502 corresponds to personal details of a candidate. The personal details of the candidate include one or more first features (depicted by 512) such as name of the candidate, address of the candidate, work permit of the candidate, or location of the candidate. Further, the second portion 504 corresponds to educational qualification of the candidate. The educational qualification of the candidate includes one or more first features (depicted by 514A, and 514B) such as name of a college, school name, or grade of the candidate.

The third portion 506 corresponds to work experience of the candidate. Further, the work experience of the candidate includes one or more first features (depicted by 516A, and 516B) such as name of a company, location of the company, accomplishments of the candidate, or time period of the candidate. Further, the fourth portion 508 corresponds to skills of the candidate. The skills of the candidate include skill description (depicted by 518). The skill description 518 corresponds to the description of the skills possessed by the candidate such as C, C++, Java, and so on. Further, the fifth portion 510 corresponds to miscellaneous details. The miscellaneous details may include one or more first features (depicted by 520) such as publications by the candidate, blog of the candidate, or other information of the candidate.

FIG. 6 is a block diagram illustrating a graphical user interface 600 presented to a user, in accordance with at least one embodiment. The graphical user interface 600 has been described in conjunction with FIG. 1, FIG. 2, FIG. 3, and FIG. 4.

The graphical user interface, GUI, (depicted by 600) is presented to the user. The GUI 600 includes a first portion 602 that may be configured to display the plurality of resumes for the job description. The GUI 600 further includes a second portion 604 that enables the user to select the scoping criterion. Further, the GUI 600 includes a third portion 606 that enables the user to select one or more first features of each of the plurality of resumes.

Based on the scoping criterion and the one or more first features, the GUI 600 further includes a fourth portion 608 that may be configured to display the ranked set of resumes. In an embodiment, the fourth portion 608 may further display the one or more second features associated with each resume in the selected set of resumes. Further, GUI 600 includes the fifth portion 610 that enables the user to provide the feedback.

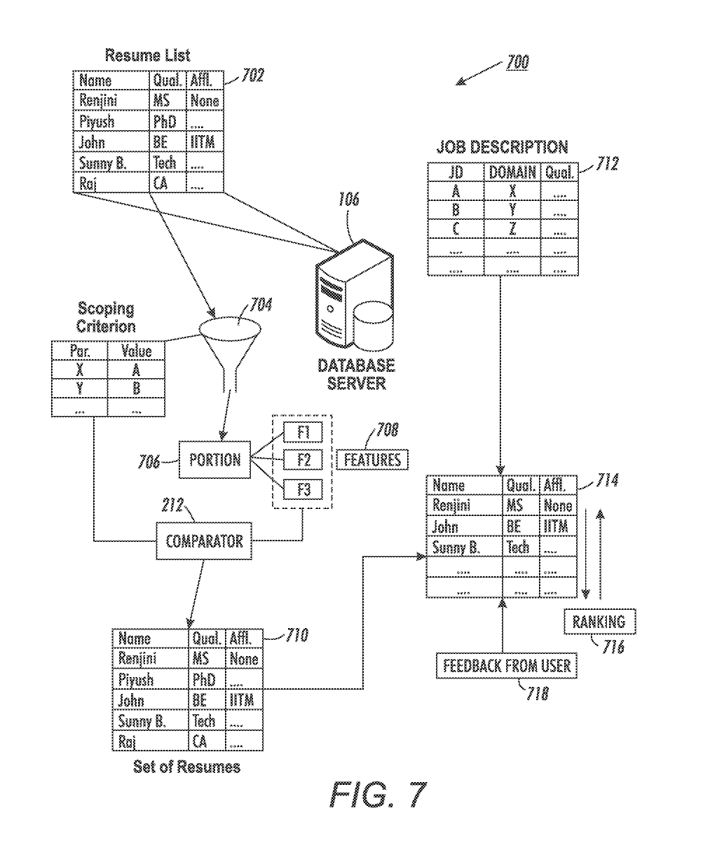

FIG. 7 is a flow diagram 700 illustrating an example of selecting a set of resumes for a job description, in accordance with at least one embodiment. The flow diagram 700 has been explained in conjunction with FIG. 1, FIG. 2, FIG. 3, and FIG. 4.

As shown in FIG. 7, a resume list (depicted by 702) includes one or more resumes. As discussed (refer step 302), in an embodiment, the resume list 702 and job description (depicted by 712) may be received from the database server 106. Further, the scoping criterion (depicted by a funnel 704) may be received from the user. In an embodiment, the scoping criterion 704 may be received from the user (refer step 306). Further, based on the received scoping criterion 704, a portion (depicted by 706) in each of the one or more resumes may be identified by using the named-entity recognition techniques or the CV parsing tools, as discussed above. Further, the portion 706 includes one or more features (depicted by 708) associated with each resume in the resume list 702. Thereafter, a set of resumes (depicted by 710) may be selected based on a comparison between the scoping criterion and the one or more features (depicted by 708).

Prior to displaying the one or more second features associated with each resume in the selected set of resumes, the weights may be assigned to the one or more second features associated with each resume in the selected set of resumes, using the equation 1 (as discussed in the step 314). Based on the assigned weights, the final score for each resume in the selected set of resumes may be determined, as discussed in the step 316. Further, the ranked set of resumes (depicted by 716) may be displayed on the graphical user interface (refer step 320) to the user. Thereafter, the one or more second features associated with each resume in the selected set of resumes (depicted by 714) may be displayed on the graphical user interface to the user. Further, a feedback (depicted by 718) may be received from the user to update the ranking of the set of resumes. The feedback may correspond to at least selecting a resume from the set of resumes or reordering of the ranked set of resumes (refer step 402).

The disclosed embodiments encompass numerous advantages. Through various embodiments for selecting a set of resumes for a job description, it is disclosed that a scoping criterion is received from a user. Further, it is disclosed that a set of resumes may be selected from the plurality of resumes based on a comparison between the received scoping criterion and one or more first features extracted from a portion in each of the plurality of resumes. Further, it is disclosed that ranking of the set of users is being displayed on a graphical user interface to the user. Based on the received ranking of the set of resumes, it is disclosed that the user provides a feedback that may allow the user to select a suitable candidate for a job opening. Thereafter, based on the feedback, the user receives the updated ranking of the set of resumes for the job opening. Thus, the disclosed embodiments enable the user (e.g., a hiring manager) to provide feedback with respect to the ranked set of candidates, which may help in making the candidate selection process more robust.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic”. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for selecting a set of resumes for a job description (JD) have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A method for selecting a set of resumes for a job description (JD), said method comprising:
extracting, by one or more microprocessors, at least a portion in each of a plurality of resumes based on a scoping criterion received from a user;
extracting, by said one or more microprocessors, one or more first features from said portion in each of said plurality of resumes;
selecting, by said one or more microprocessors, said set of resumes from said plurality of resumes based on a comparison between said one or more first features and said scoping criterion; and
displaying, by a display device, one or more second features of said selected set of resumes on a graphical user interface to said user.

2. The method of claim 1 further comprising ranking, by said one or more microprocessors, said set of resumes based on said one or more second features associated with each resume in said set of resumes and one or more third features of said job description.

3. The method of claim 2 further comprising updating, by said one or more microprocessors, said ranking based on a feedback received from said user, wherein said feedback corresponds to at least selecting a resume from said ranked resumes, or reordering said ranked resumes.

4. The method of claim 1 further comprising assigning, by said one or more microprocessors, weights to said one or more second features associated with each resume in said set of resumes.

5. The method of claim 4 further comprising determining, by said one or more microprocessors, a final score for said each resume in said set of resumes based on weights assigned to each of said respective one or more second features.

6. The method of claim 1 further comprising storing, by said one or more microprocessors, said one or more second features of each resume in said plurality of resumes as a linked list data structure.

7. The method of claim 1 further comprising enhancing, by said one or more microprocessors, each resume in said plurality of resumes by adding information related to university ranking, or ranking of a previous company.

8. The method of claim 1, wherein said scoping criterion comprises at least one of a time-based scoping, a skill domain, an educational qualification, or a job description.

9. The method of claim 1, wherein said one or more first features of each of said plurality of resumes comprise at least one of an educational qualification, a work experience, a skill set, or a university ranking.

10. A system for selecting a set of resumes for a job description (JD), said system comprising:
one or more microprocessors configured to:
extract at least a portion in each of a plurality of resumes based on a scoping criterion received from a user;
extract one or more first features from said portion in each of said plurality of resumes;
select said set of resumes from said plurality of resumes based on a comparison between said one or more first features and said scoping criterion; and
a display device configured to one or more second features of said selected set of resumes on a graphical user interface to said user.

11. The system of claim 10, wherein said one or more microprocessors are further configured to rank said set of resumes based on said one or more second features associated with each resume in said set of resumes and one or more third features of said job description.

12. The system of claim 11, wherein said one or more microprocessors are further configured to update said ranking based on a feedback received from said user, wherein said feedback corresponds to at least selecting a resume from said ranked resumes, or reordering said ranked resumes.

13. The system of claim 10, wherein said one or more microprocessors are further configured to assign weights to said one or more second features associated with each resume in said set of resumes.

14. The system of claim 13, wherein said one or more microprocessors are further configured to determine a final score for said each resume in said set of resumes based on weights assigned to each of said respective one or more second features.

15. The system of claim 10, wherein said one or more microprocessors are further configured to present said graphical user interface to said user.

16. The system of claim 15, wherein said graphical user interface comprises:
a first portion configured to display said plurality of resumes for said job description;
a second portion enabling said user to select said scoping criterion;
a third portion enabling said user to select one or more first features of each of said plurality of resumes;
a fourth portion configured to display said one or more second features of said selected set of resumes based on said selection of said one or more first features; and
a fifth portion enabling said user to provide a feedback.

17. A computer program product for use with a computer, the computer program product comprising a non-transitory computer readable medium, wherein the non-transitory computer readable medium stores a computer program code for selecting a set of resumes for a job description (JD), wherein the computer program code is executable by one or more microprocessors to:
extract, by one or more microprocessors, at least a portion in each of a plurality of resumes based on a scoping criterion received from a user;
extract, by said one or more microprocessors, one or more first features from said portion in each of said plurality of resumes;
select, by said one or more microprocessors, said set of resumes from said plurality of resumes based on a comparison between said one or more first features and said scoping criterion; and
display, by a display device, one or more second features of said selected set of resumes on a graphical user interface to said user.
